(19) United States
(12) Patent Application Publication
(10) Pub. No.: US 2007/0209763 A1
(43) Pub. Date: Sep. 13, 2007

(54) Presses with integral heaters

(76) Inventor: Junming Chen, Beijing (CN)

Correspondence Address: Daniel P. Burke-Daniel P. Burke & Associates, PLLC, Suite 131, 300 Rabro Drive, Hauppauge, NY, 11788, US

(21) Appl. No.: 11/698,436

(22) Filed: Jan. 26, 2007

Related U.S. Application Data
(60) Provisional application No. 60/780,689, filed on Mar. 9, 2006.

(51) Int. Cl. B30B 15/34

(52) U.S. Cl. 156/583.1; 156/583.3; 156/475

(57) ABSTRACT

Presses with heaters, such as mug presses, comprise a thermal sensor which is separated from a heater element by at least one layer of insulation. The thermal sensor is advantageously in electrical communication with the heating element to shut off the heating element when a predetermined temperature is reached. By spacing the thermal sensor from the actual heater, the sensor is insulated from the heater so that the temperature at the sensor will be less than the certain pre-determined temperature at the heater during heating. Accurate control of the heating of the mugs and substrate is achieved in a manner which eliminates the need for separately controlling and/or monitoring the time which the heat is applied.

### RELATED APPLICATION DATA

This application claims the benefit of U.S. provisional patent application Ser. No. 60/780,689 filed on Mar. 9, 2006.

The present invention is directed to presses, such as mug presses, comprising integral heaters which are particularly useful in applying heat to a printed substrate while the substrate is pressed against the surface of an object comprising at least one curved surface. The image on the printed substrate is thereby transferred to the surface.

### BACKGROUND

Mug presses which are used in conjunction with heaters have been previously disclosed. Such presses typically require electronic control boards for controlling the heater, the amount of heat applied to the mug, as well as the time in which the mugs need to be maintained in the press in order to affect the image transfer. One image transfer process, commonly referred to as a sublimation process, relies upon the printed substrate reaching a certain, predetermined temperature which thereby causes the ink on the substrate to transfer to the mug. For example, according to one process, a temperature of 180° C. is generally considered an ideal temperature for affecting optimum image transfer.

Typical traditional mug presses/heat presses have included a temperature control and a time controller or have combined the temperature and time controllers into a single electronic control board.

The use of electronic control boards with some previously known mug presses has been problematic in that they pose maintenance problems and have required the use of heavy subcomponents such as transformers. The size and weight of such components have made such mug presses somewhat cumbersome when it was desired to use such mug presses in remote locations such as at sporting events, birthday parties, and the like.

It would therefore be desirable to provide a more reliable mug press with an integral heater which has fewer parts, is lighter and is less expensive to manufacture.

It would also be desirable to provide a mug press with an integral heater which requires less control input from users to thereby facilitate use by unskilled operators at a wide variety of locations and/or in a wide variety of environmental conditions. For example, it would be desirable to provide a mug press with an integral heater which is equally suitable for use in a heated shopping mall as well as an open football stadium during a cold winter day.

### SUMMARY OF THE INVENTION

Embodiments of the present invention are directed to heat presses, such as mug presses, with heaters wherein a thermal sensor is separated from the heater element of the press by at least one layer of insulation. According to another embodiment, at least two layers of different types of insulation separate a thermal sensor from the heater element of the press. Another aspect of one embodiment comprises disposing the thermal sensors within a silicon rubber ring surrounding a heating element which contacts the object being printed.

The thermal sensor is advantageously in communication with the heating element to shut off the heating element when a predetermined temperature is reached.

By spacing the thermal sensor from the actual heater, the sensor is therefore somewhat insulated from the heater so that the temperature at the sensor will be less than the certain pre-determined temperature at the heater during heating. Through the present invention, accurate control of the heating of the mugs/objects and substrate is achieved in a manner which eliminates the need for separately controlling and/or monitoring the time which the heat is applied.

Since the thermal sensor is both spaced and insulated from the heater and since the substrate containing the image is closer to or in contact with the heater and the mug or other item to which the image is to be transferred, the temperature at the thermal sensor will be lower than the heater during the heating process and there will be an inherent time delay in the thermal sensor reaching elevated temperatures relative to when the temperature of the substrate/mug reaches that same temperature. The various embodiments embodiments of the present invention rely upon this time delay in order to control the time that the substrate/mug are at a predetermined temperature and, therefore eliminate the need for separate equipment to monitor the time that the heater is on and/or the time during which the heater is at a certain temperature. The various embodiments of the present invention therefore achieve a successful image transfer, while eliminating a timer thereby enabling the mug presses/heat presses of the present invention to be smaller and operated with an easier and simpler operation.

While the illustrated embodiments are mug presses, the advantages of the present invention are not limited to mug presses, and include presses for transferring images to objects, comprising at least one curved surface to be printed.

### BRIEF DESCRIPTION OF THE DRAWINGS

FIG. 1 is a top perspective view of one embodiment of the present invention in a closed configuration and with a mug shown in phantom.

FIG. 2 is a top view of the mug press and mug shown in FIG. 1.

FIG. 3 is a front view of the mug press and mug shown in FIG. 1.

FIG. 4 is a right side view of the mug press and mug shown in FIG. 1.

FIG. 5 is a perspective view of the mug press shown in FIG. 1 in an open configuration.

FIG. 6 illustrates the position of an insulated thermal sensor according to one embodiment of the present invention.

FIG. 7 is a close up view of a thermal sensor in an insulating/protective layer of the heat press as shown in FIG. 6.

FIG. 7A is an illustrative cross-section of an insulated thermal sensor.

FIG. 8 illustrates an alternative placement of a thermal sensor according to an embodiment of the present invention.

FIGS. 9 and 10 are illustrative wiring diagrams useful with presses of the present invention.

FIGS. 11 and 12 illustrate an alternative embodiment of the present invention with a mug press shown in an open and a closed configuration, respectfully.

FIG. 13 illustrates a still further embodiment of the present invention.

### DETAILED DESCRIPTION

Various aspects of the present invention are illustrated in the following drawings. These drawings are exemplary and not intended to be limiting with respect to the scope of the appended claims.

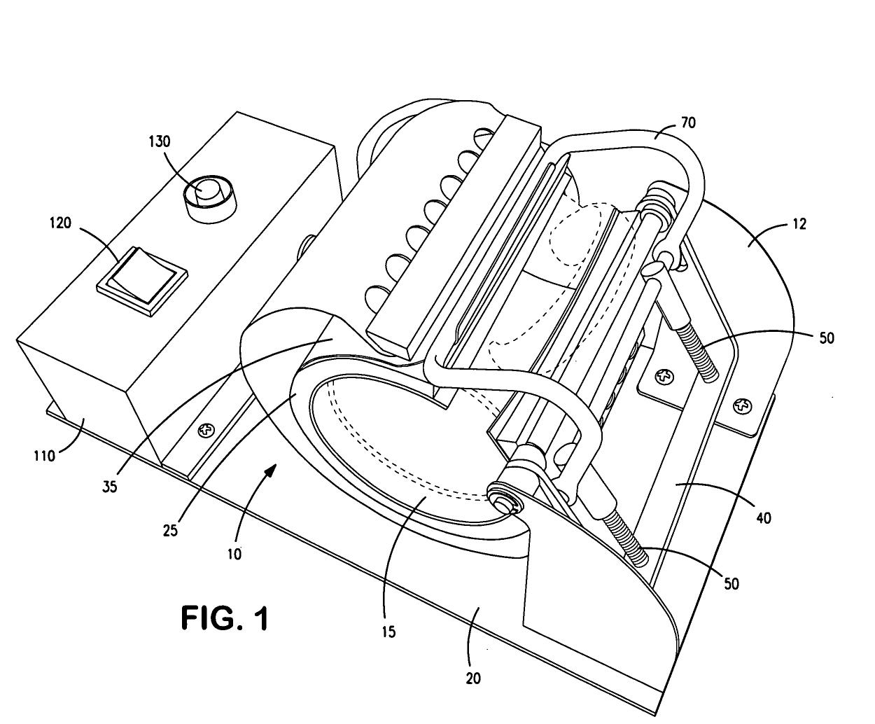

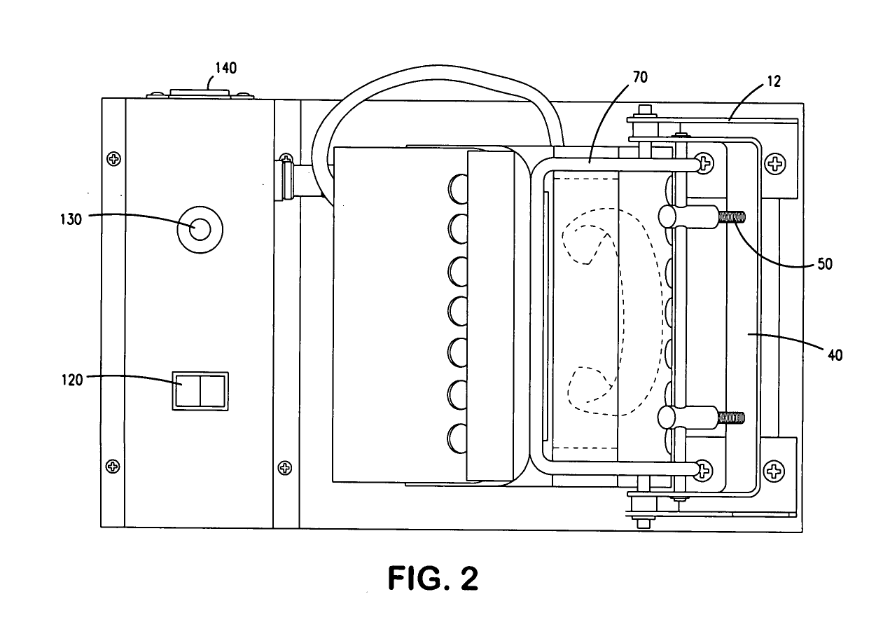

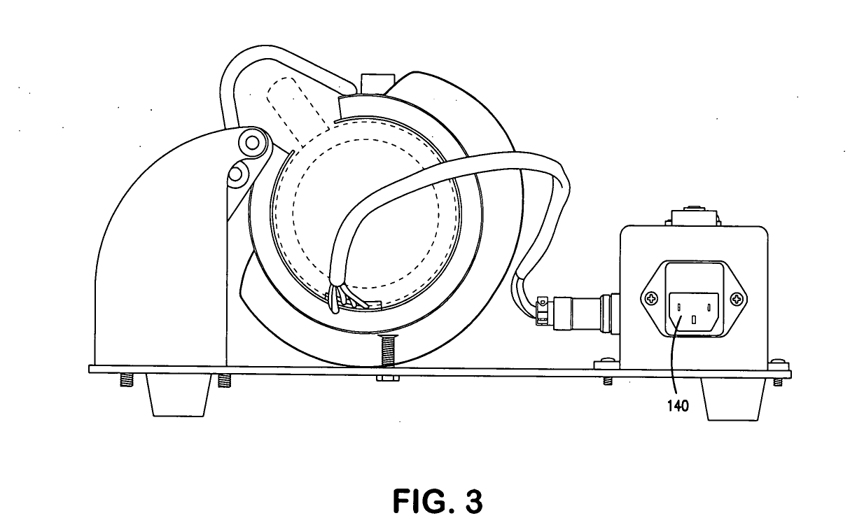

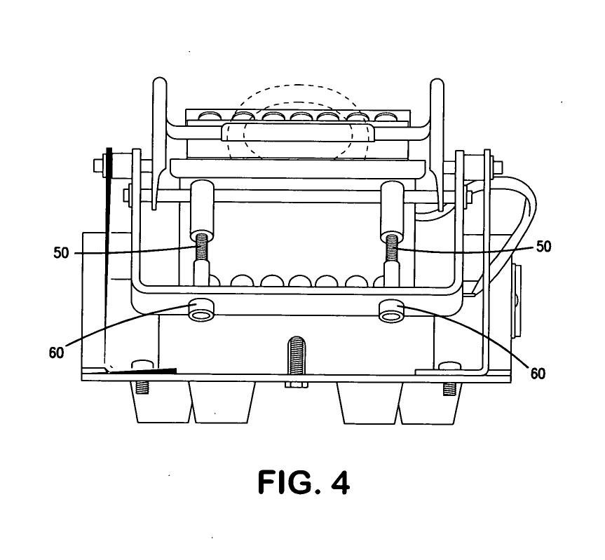

FIGS. 1-7A illustrate one preferred embodiment of the present invention. As shown in the perspective view of FIG. 1, this embodiment comprises a cuff assembly 10 mounted on a support 20, a switch box 110 comprising a switch 120 and indicator light 130 and a power supply fuse jack 140 (shown best in FIG. 4). A rack 12 supports a generally U-shaped operating handle 40, adjustment nuts 60, adjustment screws 50 and a bending bar 70. The cuff assembly 10 comprises a flexible electric heating element 15, a silicon rubber insulating layer 25 and an outer metal strip 35.

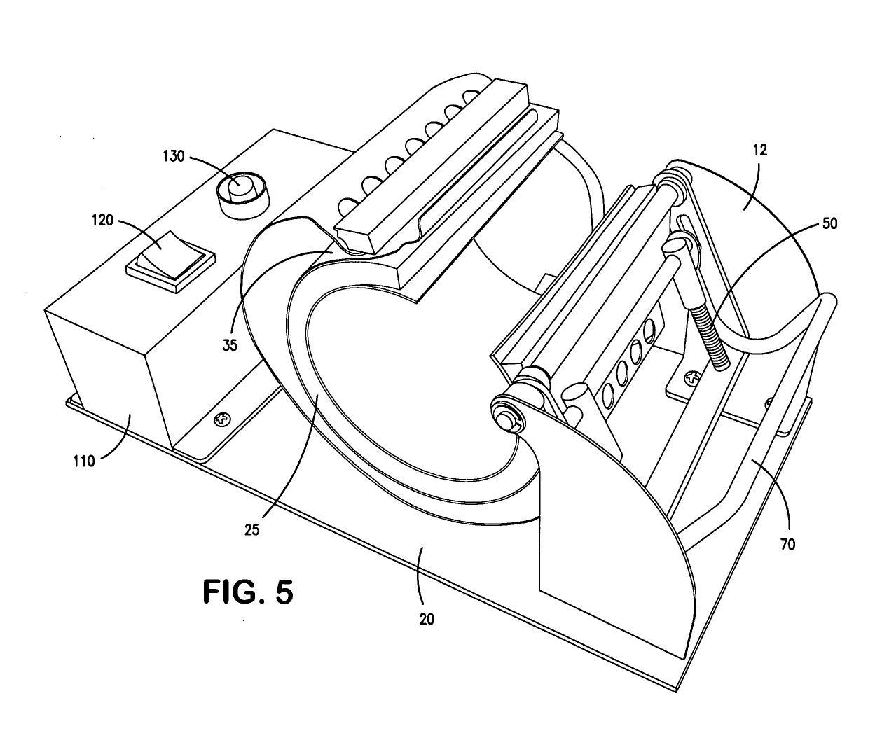

From the present description and figures, it will be appreciated that a mug comprising a handle can be placed within the cuff assembly when the press is in the open configuration shown in FIG. 5.

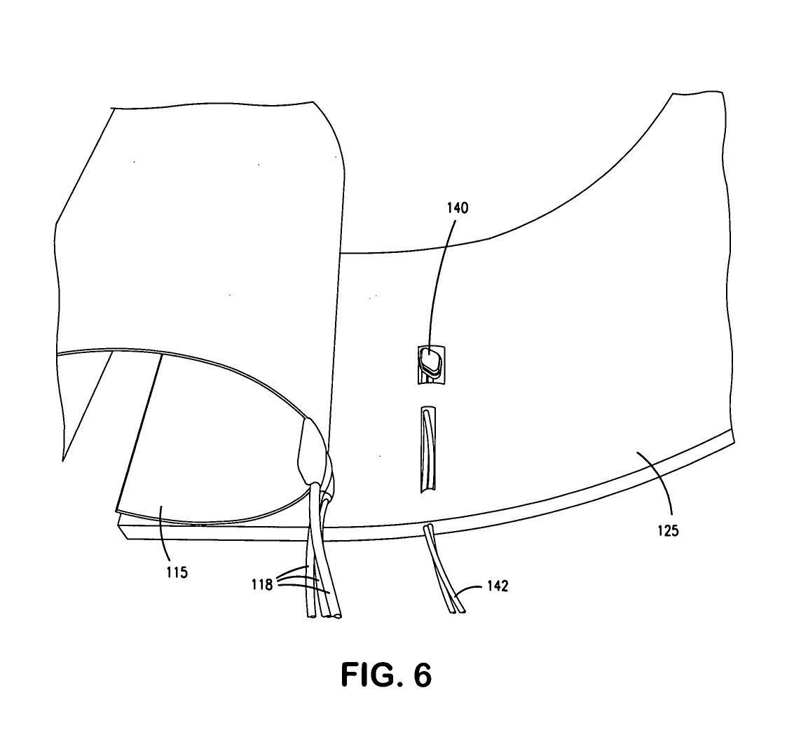

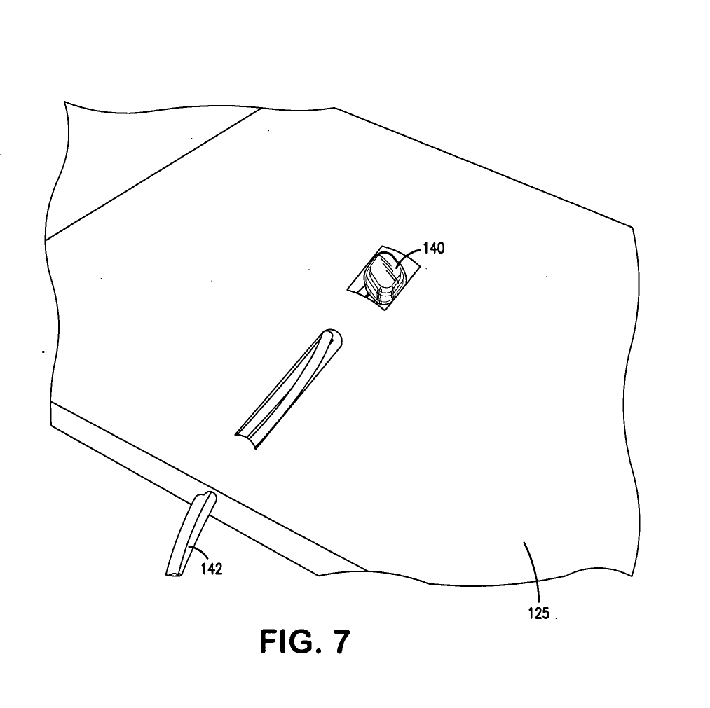

According to this preferred embodiment of the present invention, the cuff assembly comprises an electric heating element 115 which is energized by heater wires 118. A silicon rubber layer 125 is disposed around the exterior of the electric heating element 115. According to this embodiment of the present invention, a thermal sensor 140 and its thermally protected control wires 142 are embedded into relieved sections of the silicon rubber layer 125. As generally illustrated in FIG. 7A, the thermal sensor 140 is substantially enclosed within an insulator 145, e.g. a transparent silicon insulator. The details of thermal sensor 140 have not been illustrated. For example, the transparent silicon insulator preferably has a wall thickness of about 0.1 to 0.5 mm, more preferably about 0.3 mm. In this manner, the thermal sensor 140 is thermally insulated from the heater 115. According to the embodiment illustrated in FIGS. 6-7A, the transparent silicon insulation is the only insulation between the heating element 115 and the thermal sensor 140.

The heating element may have a thickness of, for example, 1.5 mm, which may be thicker or thinner depending upon the desired size of ceramic mugs used with this press. It is also within the scope of the present invention to use silicon rubber rings of varying thicknesses. As indicated in FIG. 1, the silicon ring is an open ring to facilitate the heating of a mug with a handle.

The outer metal strip 35 is provided with sufficient elasticity to firmly press the silicon ring 25 and heating element 15 around the periphery of mug or other object when the bending bar 70 is positioned under the metal lip 80 of the outer band 35 and the press is closed. The adjustment screws 50 and adjustment nuts 60 (best shown in FIG. 4) permit adjustability of the clamping force. FIG. 5 illustrates the embodiment of the present invention shown in FIG. 1 in an open configuration.

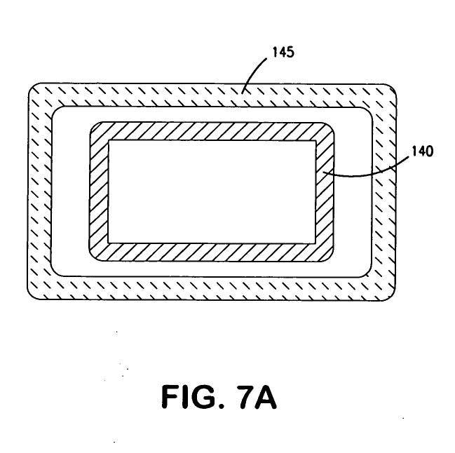

According to an alternative embodiment of the present invention diagrammatically illustrated in FIG. 8, a thermal sensor 240 is embedded within a silicon rubber ring 225 so that the silicon rubber ring 225 provides insulation between the thermal sensor 240 and the heater 215. The thermal sensor 240 can be provided with a transparent silicon insulator, such as the type shown in FIGS. 7 and 8, or can rely entirely upon the insulating properties of the silicon rubber ring 225 for the desired insulation between the sensor and the heating element 215.

According to each of the embodiments of the present invention, the temperature sensor is spaced from the heating element and is also insulated therefrom so that when the heater band is energized and heat is applied to a mug/printed substrate, there is a temperature difference between the heating element and the thermal sensor. Proper selection of the thermal sensor 140, as well as proper positioning of the thermal sensor 140 within silicon rubber ring 25 allows the desired temperature to be reached at the printed substrate/mug prior to the temperature reaching a predetermined level at the sensor. For example, if the silicon rubber has a thickness of about 8 mm, the temperature sensor 30 may be positioned 4-6 mm from the heating element 15. Therefore, for example, if the desired activation temperature for the printed substrate is 180° C., the thermal sensor 140 may be selected to send a signal when the temperature sensor reaches 160° C. Such thermal sensors are known in other arts and can operate on a nominal current.

According to a preferred embodiment of the present invention, the thermal sensor is electronically connected to the heating element 15 so that electricity to the heating element 15 is shut off when the thermal sensor 140 reaches the preset temperature. With reference to the embodiment shown in FIG. 1, in use, a mug and a printed substrate are placed within the heating element 15 of the cuff assembly 10. The power switch is then placed in the ON position which is indicated by illumination of the indicator light 130. According to this embodiment of the present invention, the heater stays activated until the thermal sensor 140 sensed a predetermined temperature, for example, 160° C. When the thermal sensor reaches the predetermined temperature, the heater is automatically deactivated.

According to another aspect of the present invention, the sensor and heating element can be wired so that the heating element will be reactivated when the sensor temperature drops below a certain temperature, for example, 150° C., thereby switching on the power supply to the heating element. According to embodiments with this feature, once the main switch 120 has been turned on, the thermal sensor controls the activation of the heater and the status of the heater is indicated by the indicator light 130.

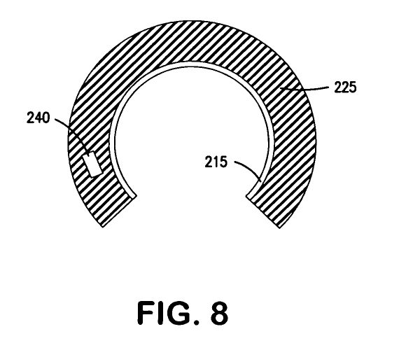

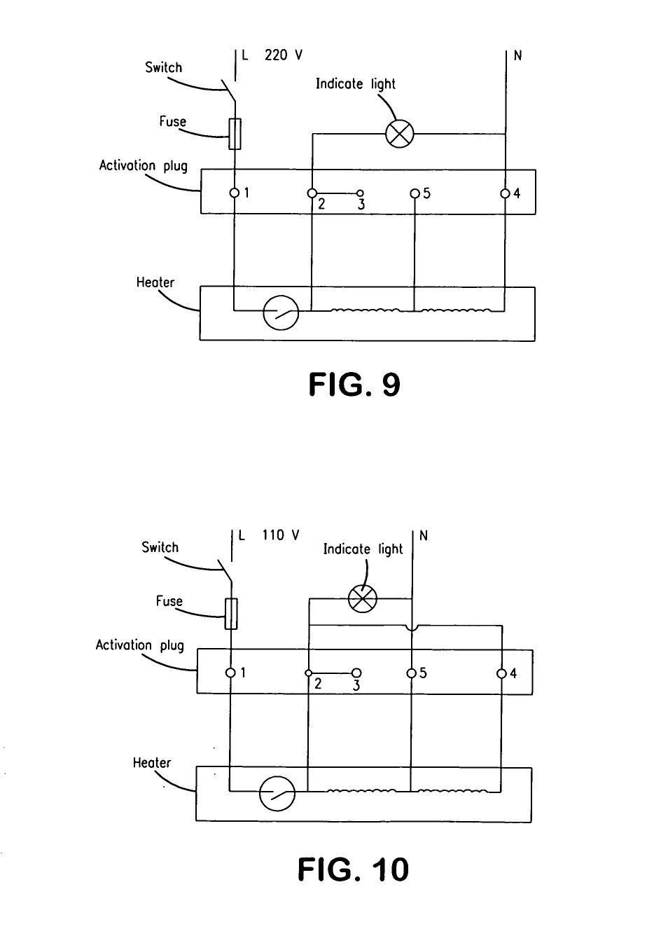

FIGS. 9 and 10 are illustrative wiring diagrams for use with the mug presses of the present invention with 220 volts and 110 volts, respectively.

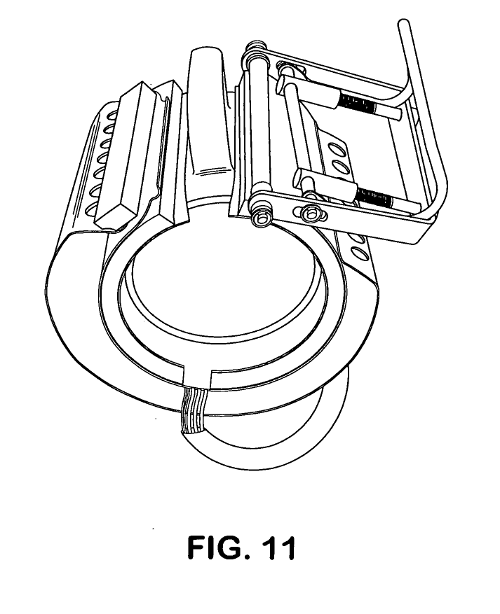

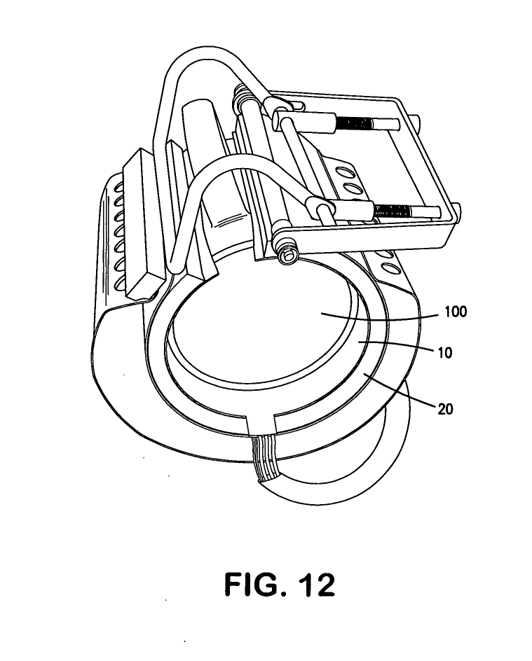

FIGS. 11 and 12 illustrate an alternative embodiment of the present invention wherein a similar mug press is provided without a support, switch, indicator light. The power source of this embodiment is not illustrated, but preferably simply comprises an AC cord designed for insertion into a conventional outlet. This embodiment is particularly portable and relies solely upon thermal sensor of the type described above for activation and deactivation of the heater. FIG. 12 illustrates the embodiment of the present invention shown in FIG. 12 with a mug in the closed configuration.

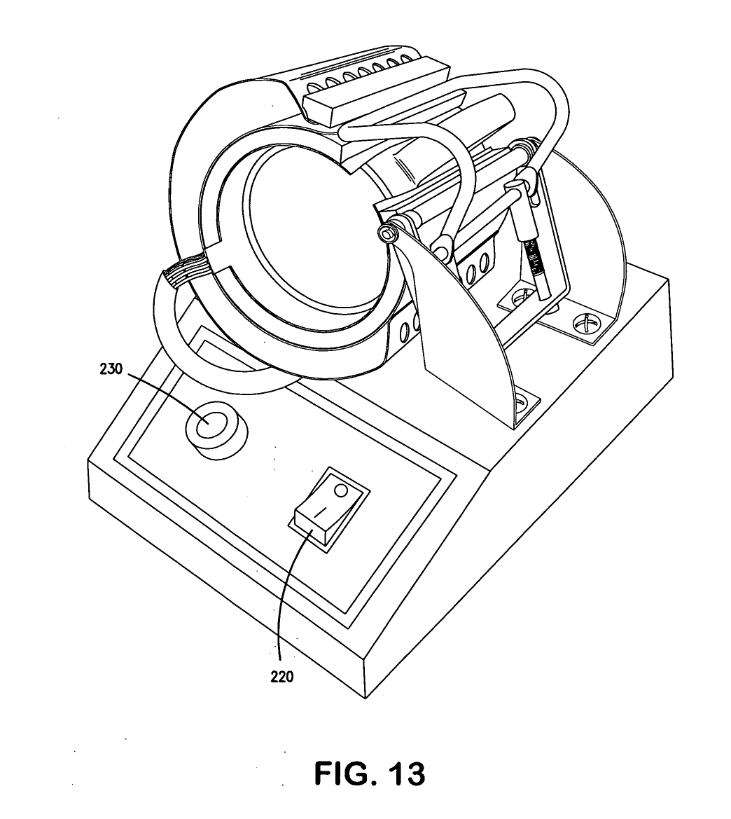

FIG. 13 illustrates a still further configuration of the present invention wherein the activation switch 220 and indicator light 230 are positioned toward the front of the mug press, rather than to the side.

It is also within the scope of the present invention to locate the temperature sensor further or closer to the heater band, as desired. The present invention eliminates the need for a timing mechanism and/or an electronic control board, along with their inherent costs and disadvantages. The embodiments of the present invention also provide for an accurate measurement of the temperature at a location proximate to, but spaced from, the heating element and minimize the need for special training of technicians.

While the illustrated embodiments of the present invention are shown for use with mugs, the heater presses of the present invention are also used for printing on other objects comprising generally round shapes, such as piggy banks, vases, and the like.

1. A press for applying heat and pressure to a substrate comprising a printed image for transferring said image to an object comprising a generally curved surface comprising:
a cuff assembly movable between an open position, adapted to receive said object and a printed substrate, and a closed position wherein said substrate is maintained in contact with said object, said cuff assembly comprising:
a flexible, electric heating element,
a thermal sensor, operative to provide an indication which terminates the flow of electricity to said heating element when said thermal sensor reaches a pre-determined temperature,
said thermal sensor disposed in spaced relation to said heating element and in electrical communication with said heating element; and
at least one thermal insulator disposed between said heating element and said thermal sensor.

2. A press according to claim 1 comprising a plurality of thermal insulators disposed between said heating element and said thermal sensor.

3. A press according to claim 2 wherein at least two of said insulators are different types of insulators.

4. A press according to claim 3 wherein at least two of said different types of insulators comprise silicon.

5. A press according to claim 4 wherein at least one of said insulators comprises a transparent silicon.

6. A press according to claim 5 wherein at least one of said insulators comprises a silicon foam.

7. A press according to claim 5 wherein at least one of said insulators comprises silicon rubber.

8. A press according to claim 2 wherein at least one of said insulators comprises a transparent silicon.

9. A press according to claim 2 wherein at least one of said insulators comprises a silicon foam.

10. A press according to claim 2 wherein at least one of said insulators comprises silicon rubber.

11. A press according to claim 1 wherein said at least one insulator comprises silicon.

12. A press according to claim 1 wherein said at least one insulator comprises transparent silicon.

13. A press according to claim 1 wherein said at least one insulator comprises silicon foam.

14. A press according to claim 1 wherein said at least one insulator comprises silicon rubber.

15. A press according to claim 1 wherein said cuff assembly comprises a silicon ring extending around at least a portion of said heating element, said silicon ring comprising an interior surface in contact with said heating element and an exterior surface, said thermal sensor is disposed between said interior surface and said exterior surface of said silicon ring.

16. A press according to claim 15 wherein said press is a mug press.

17. A press according to claim 15 wherein said thermal sensor is at least partially surrounded by a second silicon insulator other than said silicon ring.

18. A press according to claim 17 wherein said second silicon insulator comprises a transparent silicon.

19. A press according to claim 18 wherein said press is a mug press

20. A press according to claim 1 wherein said sensor further reactivates said heater when a second, lower predetermined temperature is sensed.

21. A press for applying heat and pressure to a substrate comprising a printed image for transferring said image to an object comprising at least one generally curved surface comprising:
a cuff assembly movable between an open position, adapted to receive said object and a printed substrate, and a closed position wherein said substrate is maintained in contact with said object, said cuff assembly comprising:
a flexible, electric heating element,
a thermal sensor in electrical communication with said heating element, said thermal sensor operative to provide an indication which terminates the flows of electricity to said heating element when said thermal sensor reaches a pre-determined temperature,
said thermal sensor disposed in spaced relation to said heating element;
at least one thermal insulator disposed between said heating element and said thermal sensor;
said cuff assembly comprising a silicon ring extending around at least a portion of said heating element, said silicon ring comprising an interior surface in contact with said heating element and an exterior surface, said thermal sensor is disposed between said interior and exterior surfaces of said silicon ring; and
said thermal sensor is at least partially surrounded by a second silicon insulator other than said silicon ring.

22. A press according to claim 22 wherein said second silicon insulator comprises a transparent silicon.

23. A press according to claim 21 wherein said press is a mug press

24. A press according to claim 21 wherein said sensor further reactivates said heater when a second, lower predetermined temperature is sensed.
